(19) United States
(12) Patent Application Publication
(10) Pub. No.: US 2013/0022525 A1
(43) Pub. Date: Jan. 24, 2013

(54) METHODS AND COMPOSITIONS FOR DRYING IN THE PREPARATION OF RADIOPHARMACEUTICALS

(71) Applicants: Dennis B. ESHIMA, Phoenix, AZ (US); Mehmet Husnu, Phoenix, AZ (US); Henry Padgett, Hermosa Beach, CA (US); Thomas A. Klausing, Powell, OH (US); Chad E. Bouton, Powell, OH (US); Herman Benecke, Columbus, OH (US); Daniel B. Garbark, Blacklick, OH (US)

(72) Inventors: Dennis B. ESHIMA, Phoenix, AZ (US); Mehmet Husnu, Phoenix, AZ (US); Henry Padgett, Hermosa Beach, CA (US); Thomas A. Klausing, Powell, OH (US); Chad E. Bouton, Powell, OH (US); Herman Benecke, Columbus, OH (US); Daniel B. Garbark, Blacklick, OH (US)

(73) Assignee: CARDINAL HEALTH 414, LLC

(21) Appl. No.: 13/550,188

(22) Filed: Jul. 16, 2012

Related U.S. Application Data
(60) Provisional application No. 61/508,464, filed on Jul. 15, 2011.
(60) Provisional application No. 61/508,294, filed on Jul. 15, 2011.

(51) Int. Cl. C01B 7/00; C09K 3/00

(52) U.S. Cl. 423/249; 252/184

(57) ABSTRACT

A method of drying a radioisotope solution having radioisotopes includes passing the radioisotope solution through a solid phase extraction column containing an anion exchange group, thereby trapping the radioisotopes in the column. The method also includes passing an eluent through the column, thereby removing the radioisotopes from the column. The eluent includes a cation trapping agent/salt complex, less than 4% water, and the remainder is a solvent. A method of producing the eluent includes reacting a cation trapping agent with a salt in the presence of less than 4% water and a solvent to form solubilized cation trapping agent/salt complex, wherein one of the cation trapping agent and the salt is present in en excess of a stoichiometric amount and ending the reaction when a predetermined amount of solubilized cation trapping agent/salt complex has been formed.

### CROSS REFERENCE TO RELATED APPLICATIONS

This application claims priority to U.S. Provisional Application No. 61/508,464, entitled “METHODS AND COMPOSITIONS FOR DRYING IN THE PREPARATION OF RADIOPHARMACEUTICALS” filed on Jul. 15, 2011; and to U.S. Provisional Application No. 61/508,294 entitled “SYSTEMS, METHODS, AND DEVICES FOR PRODUCING, MANUFACTURING, AND CONTROL OF RADIOPHARMACEUTICALS—FULL” filed on Jul. 15, 2011. The entirety of each of the preceding applications is incorporated by reference herein.

### FIELD OF THE INVENTION

Aspects of the present relation relate to methods and compositions for drying radioisotope solutions and for reducing synthesizing time of radioisotopes.

### BACKGROUND OF THE INVENTION

Positron Emission Tomography (PET) is a nuclear medicine imaging technique in which a positron-emitting radionuclide, such as carbon-11, nitrogen-13, oxygen-15 or fluorine-18, is chemically incorporated into a compound normally used by the body, such as glucose, water or ammonia. The compound may then be injected into a patient, for example, so that a targeted biological process of the body will naturally distribute the compound. The radionuclide serves as a tracer for subsequent imaging by a scanner, wherein the decay of the radioisotope produces a record of the concentration of the tissue in the area being imaged, providing a practitioner detailed views of a targeted anatomy in a patient when combined with a Computerized Tomography (CT) study (CT/PET).

Nuclear medicine requires special considerations in the preparation, handling and delivery of radioactive materials for use in various medical procedures. For example, fluorodeoxyglucose (FDG), an analogue of glucose, is commonly used for the chemical incorporation of the radioisotope fluorine-18 for use in PET procedures. Fluoride-18 is produced in a medical cyclotron, usually from oxygen-18. In particular, Fluoride-18 is produced by proton bombardment of oxygen-18 enriched water through the ¹⁸O(p,n)¹⁸F nuclear reaction. Fluoride-18 is then recovered as an aqueous solution of fluoride-18 (H₂O/¹⁸F⁻). However, the aqueous solution comprises mostly water and a very small amount of fluoride-18. For example, the solution may contain a small fraction of fluoride-18. For example, the mole fraction of Fluoride-18 to Oxygen-18 is often on the order of 10⁻⁸. Because water can interfere with subsequent key reactions when producing a radiolabeled product, it is necessary remove the water (e.g. prior to the labeling reaction).

Coenen et al., J. Labelled Comd. Radiopharm., 1986, vol. 23, pp. 455-467, discloses fluoride-18 recovery carried out in two steps, extraction and elution. First the anions are separated from the oxygen-18 enriched water and trapped on a resin The anions, including fluoride-18, are then eluted into a mixture containing water, organic solvents, an activating agent or phase transfer agent or phase transfer catalyst, such as for example the complex potassium carbonate-Kryptofix 222. Typically, these eluents included a significant amount of water, such as around 10% to 15% by volume because it was thought that water was required to effectively solubilize potassium carbonate that has low solubility in the organic solvent and thus help shift the equilibrium between Kryptofix 222 and potassium carbonate to the Kryptofix 222/potassium carbonate complex. The most usual labeling method, known as nucleophilic substitution, however, requires anhydrous or very low water content solutions. Thus, an evaporation step (or drying step) is still necessary after fluoride-18 recovery to remove the excess water.

The removal or reduction of water prior to labeling, referred to as drying in this application, can take a significant amount of time. A known method for drying is azeotropic distillation, or evaporation, which is feasible in certain solvents such as acetonitrile which form azeotropes with water. In such solvents, water and solvent co-distil at a certain composition and boiling temperature characteristic of that azeotrope. The azeotropic composition and boiling temperature of the acetonitrile/water azeotrope is 16.3% and 77° C., respectively. However, evaporating off the water can require several distillation cycles and requires inputting a significant amount of energy. Obtaining suitably pure fluoride-18 using these procedures can take about 10 to 15 minutes. Reducing this time has significant impact on the process efficiency for radiopharmaceuticals (e.g., FDG) that incorporate fluoride-18 and other medical radioisotopes that have short half-lives. For example, the half life of fluorine-18 is only 109.8 minutes so decreasing the time required to produce the radiopharmaceutical results in increased activity available for its intended pharmaceutical use.

WO 2009/003251 attempts to solve the above-described problem by providing a low water content alternative eluent. WO 2009/003251 describes a method of separating fluoride-18 from water without an evaporation step, which includes passing fluoride-18 solution through an extraction column and eluting the fluoride-18 with an eluting solution. The eluting solution is an organic solution having an organic solvent, a molecule containing at least one acidic hydrogen, and an organic base sufficiently strong to tear off the acidic hydrogen of the molecule containing acidic hydrogen, leading to the formation of an organic salt. However, because the eluent is an organic solution comprising an organic acid and an organic base to make a salt, the eluent solution requires significant preparation cost.

It is known to reduce the number of azeotropic distillation (or evaporation) steps by using an eluent having 96:4 by volume acetonitrile-water mixture containing Kryptofix 222 and potassium carbonate (molar ratio 2:1). See N. A. Gomzina, et al., Optimization of Automated Synthesis of 2-[18F]Fluoro-2-deoxy-D-glucose Involving Base Hydrolysis, Institute of Human Brain, Radiochemistry Vol. 44, pp. 403-409 (2002). However, one cycle of azeotropic distillation is still required, adding time to the overall process.

Thus, there is a need in the art for an improved low water content eluent composition and an improved method of drying an aqueous solution comprising radioisotopes (e.g., fluoride-18) without the need for azeotropic distillation.

### SUMMARY OF THE INVENTION

Aspects of the present invention overcome the above identified problems, as well as others, by providing methods and compositions for drying a radioisotope solution.

An aspect of the present invention includes a method of drying a radioisotope solution having radioisotopes, the method including passing the radioisotope solution through a solid phase extraction column containing an anion exchange group, thereby trapping the radioisotopes in the column and passing an eluent through the column, thereby removing the radioisotopes from the column, wherein the eluent includes a solubilized cation trapping agent/salt complex, less than 4% water, and the remainder solvent.

Another aspect of the present invention includes an eluent composition for drying a radioisotope solution having radioisotopes, the composition including from a solubilized cation trapping agent/salt complex, less than 4% water, and the remainder is a solvent.

Still another aspect of the present invention is a method of preparing an eluent including reacting a cation trapping agent with a salt in the presence of less than 4% water and a first solvent to form solubilized cation trapping agent/salt complex, wherein one of the cation trapping agent and the salt is present in an excess of a stoichiometric amount and ending the reaction when a predetermined amount of solubilized cation trapping agent/salt complex has been formed.

Additional advantages and novel features relating to aspects of the present invention will be set forth in part in the description that follows, and in part will become more apparent to those skilled in the art upon examination of the following or upon learning by practice thereof.

### BRIEF DESCRIPTION OF THE DRAWINGS

Aspects of the present invention will become fully understood from the detailed description given herein below and the accompanying drawings, which are given by way of illustration and example only and thus not limited with respect to aspects of the present invention, wherein:

FIG. 1 is a graph showing the effectiveness of various eluents in removing fluoride-18 from a QMA column;

FIG. 2 shows a schematic of a heating aspect of the present invention; and

FIG. 3 shows a schematic of another heating aspect of the present invention.

### DETAILED DESCRIPTION

Aspects of the present invention are directed to eluent compositions and drying methods designed to reduce the preparation time of radioisotopes, such as, fluoride-18, which is then coupled with radiopharmaceutical precursors to prepare radiopharmaceuticals, such as, FDG. Aspects of the present invention are also directed to methods of making eluent compositions.

### Drying Methods

Before the drying method is implemented, a radioisotope solution is prepared by known methods. As an example, fluoride-18 may be produced in a medical cyclotron by proton bombardment of oxygen-18 enriched water through the ¹⁸O(p,n)¹⁸F nuclear reaction. Fluoride-18 is then recovered as an aqueous solution of fluoride-18 (H₂O/¹⁸F⁻). Similarly, other isotope solutions may be prepared, for example, iodine-123, iodine-125, or iodine-131.

When producing a radioisotope, such as fluoride-18, the resulting solution contains a small fraction of radioisotope, such as fluoride-18, and comprises a large fraction of oxygen-18 enriched water. For example, the solution may contain a mole fraction of radioisotope, such as fluoride-18 to oxygen-18 on the order of 10⁻⁸. For purposes of synthesizing a radiopharmaceutical, only the radioisotope, such as fluoride-18 is needed, while the remaining oxygen-18 enriched water is a byproduct. Therefore, it is desirable to remove the excess water efficiently and quickly so that the pure radioisotope, such as fluoride-18, may be used to synthesize the radiopharmaceutical, in particular, FDG when fluoride-18 is the radioisotope.

After the radioisotope solution containing radioisotopes has been prepared, the first step in an aspect of the drying process is to pass the solution through a solid phase extraction column containing an anion exchange group, such as a quaternary trimethylammonium (QMA) column. When fluoride-18 is the radioisotope, as the solution passes through the QMA column, the QMA column traps the fluoride-18 along with some of the water, while a majority of the water passes completely through the column. Thus, after the first step, the QMA column has trapped the radioisotopes and is wetted. In an aspect of the present invention, a dry gas, such as nitrogen, may be optionally flushed through the column after the fluoride-18 solution is passed through the column to improve the water removal.

Because the radioisotopes and some water are trapped in the column after the first step, it is necessary to remove the radioisotopes from the column. As mentioned above, it was previously thought that a significant amount of water was necessary in an eluent to provide sufficient concentration of cation trapping agent/salt complex for the eluent to be effective in removing radioisotopes from the column. It has been surprisingly found that a low water content eluent having a sufficient concentration of cation trapping agent/salt complex effectively remove the radioisotopes from the column. In particular, the eluent includes a cation trapping agent/salt complex, less than 4% by volume of water, and the remainder solvent. For example, when the radioisotopes are fluoride-18 and a QMA column is used, the cation trapping agent and the salt, forming a complex, pulls the fluoride-18 from the QMA column. Because there is less than 4% by volume of water in the eluent, yet there is sufficient concentration of cation trapping agent/salt complex present, the eluent is still effective in removing radioisotopes from the column, the additional evaporation step to remove water before radiolabeling is not necessary. The eluent formulation therefore includes active complexes, without the need for a significant amount of water (e.g., 4-15% by volume) that was used previously. Because the eluent formulation requires a low amount of water, a separate evaporation step or steps has been entirely avoided and the production time of useable fluoride-18 is reduced from approximately 10-15 minutes to 30 seconds to 1 minute. Methods of preparing such an eluent are described in detail herein.

Low water content means less than 4% by volume water, more preferably less than 3% by volume water, and even more preferably less than 1% by volume water, and still more preferably approximately 0% by volume water. It has been found that with very low water content (e.g., nearly 0%) eluent, a relatively larger volume is required to remove a high percentage (e.g., 99%) of the fluoride-18 from the column, as compared to an eluent having higher water content (e.g., 4 to 12.5%), if the potassium carbonate complex concentration is not increased relative to a conventional eluent. A conventional eluent is defined herein as comprising 37.6 mg of Kryptofix 222, 9.52 mg of potassium carbonate, 0.7 mL of acetonitrile, and 0.1 mL of water. Thus, the conventional eluent has a Kryptofix 222/potassium carbonate complex concentration of 55.6 mg/mL, which for comparative purposes is referred herein as “1 CCU.” For example, 2 CCU's would have double the concentration, (111.2 mg/mL of Kryptofix 222/potassium carbonate complex). However, it has been found that when the potassium carbonate complex concentration is increased from 1 CCU, the above described effect is reduced. Furthermore, the volume required is comparatively higher when other factors are kept constant, such as the size of the QMA column. Specifically, the volume of the eluent may be 1.5 to 2 times larger than the volume required by an eluent with water, but the actual volume of eluent required is reduced by a factor of approximately 3 times as compared to the same QMA column using 1 CCU. Therefore the actual volume of eluent required is still lower than a volume of eluent when a conventional eluent is used.

In addition to the cation trapping agent/salt complex, and the water, the remaining volume percent of the eluent is solvent. In an aspect of the present invention the solvent is acetonitrile. In general, alternate solvents may be used ranging from those that have minimal solubility in water to those that have high solubility in water. Preferable alternate solvents would be those that have at least a partial solubility for water based on the purification schemes that follow reaction of complexed radioisotope (e.g., fluoride-18) with radiolabeled drugs (e.g., FDG precursors).

Other examples of cation trapping agents usable in the eluent are crown ethers, calixarenes, cyclodextrins, and ethylenediamine tetraacetic acid (EDTA) and its derivatives. Other examples of salts useable in the eluent are salts having a cation from group 1A and 2A elements, and an anion selection from hydroxides, carboxylates, thiocarboxylates, thiolates, and halogens other than fluorine.

A cation trapping agent is used because it contains a cavity for trapping a cation on the inside and an anion on the outside. Trapping a cation within a cation trapping agent results in activation of the originally-paired anion in a number of reactions including exchange reactions. This is because the act of separating the anion from the cation significantly reduces cation-anion ion-pairing effects in solution which typically diminishes the reactivity of that anion. While any cation trapping agent that is capable of performing the above-described function is within the scope of the invention, it has been found that complexes including a cryptand, available under the trade name Kryptofix, and potassium carbonate K₂CO₃, are suitable. In particular, in a preferred aspect, the complex includes 1,10-diaza-4,7,13,16,21,24-hexaoxabicyclo[8.8.8]-hexacosane, available under the trade name Kryptofix 222, and potassium carbonate K₂CO₃. When the cation trapping agent is Kryptofix 222 and the salt is potassium carbonate, the amount of the complex is about 20 mg/mL to about 500 mg/mL, more preferably about 50 mg/mL to about 250 mg/mL, and still more preferably about 50 mg/mL to about 100 mg/mL.

In other aspects, depending on the radiopharmaceutical being produced, other eluents having different components may be used. For example, the eluent may include tetrabutylammonium bicarbonate when preparing [18F]-3′-fluoro-3′-deoxy-L-thymidine (FLT) and 18F-fluoromisonidazol (FMISO). The eluent may include tetraethyl amine potassium carbonate when preparing PPA. The eluent may include ethanol, potassium methanesulfonate, and tetrabutylammonium bicarbonate when preparing F-18 florbetaben.

With respect to Kryptofix 222/K₂CO₃ complex, each Kryptofix molecule has a cavity which has a potassium cation in the inside and the carbonate on the outside. The stoichiometry of this complex is two Kryptofix molecules bearing one potassium cation and one carbonate anion since this anion has a double negative charge. This complex, when flushed through the QMA column containing fluoride-18 will enter an exchange process with the fluoride-18. During the exchange process the fluoride-18 anion is exchanged with the carbonate, thereby attaching the fluoride-18 onto the Kryptofix 222 bearing a potassium cation. This modified complex having the fluoride-18 attached passes through the column into a reaction vessel, thereby delivering pure fluroride-18 in an anhydrous or nearly anhydrous state where it reacts with the FDG precursor.

As discussed above any eluent may be used if it is capable of performing the above-described function of removing radioisotopes from a column. Therefore, it is within the scope of the invention that any eluent having an agent capable of trapping a cation and removing radioisotopes from a solid phase extraction column, a salt, and little to no water, may be used.

In another aspect of the invention, an additional step of flushing the column with an organic solvent may be implemented before flushing the column with eluent to provide more improved water removal. The organic solvent acts to push the trapped water off the column while leaving the radioisotope on the column. The organic solvent may be any solvent that sufficiently pushes water from the column without interacting with the radioisotope trapped on the column and has appreciable water solubility. In an aspect the organic solvent may be selected from the group consisting of acetonitrile (ACN), dimethylsulfoxide (DMSO), dimethylacetamide, dimethylformamide (DMF), tetrahydrofuran (THF), dioxane, acetone, isobutyronitrile, cyclopropyl cyanide, diethylcarbonate, sulfolane, hexamethylphosphotriamide (HMPA/HMPT), I,3-Dimethyl-2-imidazolidinone (DMI), 3-methoxypropionitrile, n-butyronitrile, propionitrile, cyclopropylacetonitrile, trimethylacetonitrile, valeronitrile, methoxyacetonitrile, 1,4-dicyanobutane, glutaronitrile, 1,4-dicyanobutane, dimethylacetonitrile, and the like, or any mix of several of these solvents. Preferably, the organic solvent may be selected from acetonitrile (ACN), dimethylsulfoxide (DMSO), dimethylacetamide, dimethylformamide (DMF), tetrahydrofuran (THF), dioxane, acetone, isobutyronitrile, cyclopropyl cyanide, diethylcarbonate, sulfolane. In a preferred aspect the organic solvent is acetonitrile. It is within the scope of the invention that any nitrile may be used because they are polar aprotic solvents. The amount of organic solvent should be selected so that it sufficiently removes the water from the column, which is dependent on the amount of media in the column, size of the column, and the particular solvent, among other factors. For example, it has been found that about 1 ml of acetonitrile is sufficient to remove the water from the column when the amount of media in the column is about 0.15 ml.

In another aspect of the invention, an additional step of flushing the column with a high pressure inert dry gas may be implemented after the organic solvent flush, but before the eluent flush, to provide more improved water removal. The gas may be any dry inert gas that sufficiently pushes solvent from the column without interacting with the radioisotope trapped on the column. In an aspect, the gas may be selected from the group consisting of air, nitrogen, helium, and argon. In a preferred aspect the gas may be nitrogen. Any amount of pressure sufficient to push the organic solvent from the column may be used. In an exemplary aspect, 25 PSI of dry nitrogen is sufficient to remove the organic solvent.

### EXAMPLES

In the following examples fluoride-18 in oxygen-18 enriched water was delivered from a cyclotron to a QMA column. Then, acetonitrile was pumped through the column. Next, an eluent was pumped through the column. Examples 1-6 in Table 1 use the conventional eluent which has 12.5% by volume water content. Examples 7-12 in Table 2 use anhydrous (water content less than 4% by volume) eluents. The data in the following tables were obtained.

TABLE 1

| | | | | | | | Percent |
|---|---|---|---|---|---|---|---|
| | | | | | | Percent | Fluoride-18 |
| | | | Activity | Activity | | Fluoride-18 | Removed |
| | | Eluent | Taken Off | Left on | Time Delta | Removed | (CZT |
| Example | Eluent | Volume | Column | Column | (min) | (Biodex) | Sensor) |
| 1 | 12.5% H20, | 0.3 | 88 | 68.6 | 23 | 53 | 73 |
| | 1 CCU | | | | | | |
| 2 | 12.5% H20, | 0.3 | 55 | 82.6 | 25 | 36 | 61 |
| | 1 CCU | | | | | | |
| 3 | 12.5% H20, | 0.3 | 37 | 36.4 | 22 | 47 | 74 |
| | 1 CCU | | | | | | |
| 4 | 12.5% H20, | 0.5 | 43 | 7 | 37 | 83 | N/A |
| | 1 CCU | | | | | | |
| 5 | 12.5% H20, | 0.5 | 23 | 1.4 | 62 | 92 | 85 |
| | 1 CCU | | | | | | |
| 6 | 12.5% H20, | 0.5 | 14 | 0 | 53 | 100 | 81 |
| | 1 CCU | | | | | | |

TABLE 2

| | | | | | | | Percent |
|---|---|---|---|---|---|---|---|
| | | | Activity | | | Percent | Fluoride-18 |
| | | | Taken | Activity | | Fluoride-18 | Removed |
| | | Eluent | Off | Left on | Time Delta | Removed | (CZT |
| Example | Eluent | Volume | Column | Column | (min) | (Biodex) | Sensor) |
| 7 | 0% water, 0.76 | 0.3 | 88 | 68.6 | 23 | 53 | 73 |
| | CCU | | | | | | |
| 8 | 0% water, 0.76 | 0.3 | 55 | 82.6 | 25 | 36 | 61 |
| | CCU, delivered in | | | | | | |
| | two 0.5 mL steps | | | | | | |
| 9 | 0% water, 0.76 | 0.3 | 37 | 36.4 | 22 | 47 | 74 |
| | CCU | | | | | | |
| 10 | 0.5% H20, 1.1 | 0.5 | 43 | 7 | 37 | 83 | N/A |
| | CCU | | | | | | |
| 11 | 0.5% H20, 1.1 | 0.5 | 23 | 1.4 | 62 | 92 | 85 |
| | CCU | | | | | | |
| 12 | 1.1 to 1.2% H20, | 0.5 | 14 | 0 | 53 | 100 | 81 |
| | 2 CCU | | | | | | |

Additional tests were conducted to determine the percent of fluoride-18 removed from the QMA column using the conventional eluent having 12.5% by volume water content and several formulations of inventive eluents having less than 4% by volume water content. The testing method follows the same steps described above with respect to Examples 1-12.

The makeup of the example eluents tested are providing in Table 3.

TABLE 3

| Example | Eluent Composition |
|---|---|
| 13 | 0.34% water, .901 CCU |
| 14 | 0.34% water, 1.2 CCU |
| 15 | 0.98% water, 2.6 CCU |
| 16 | 1.55% water, ~3.8 CCU |

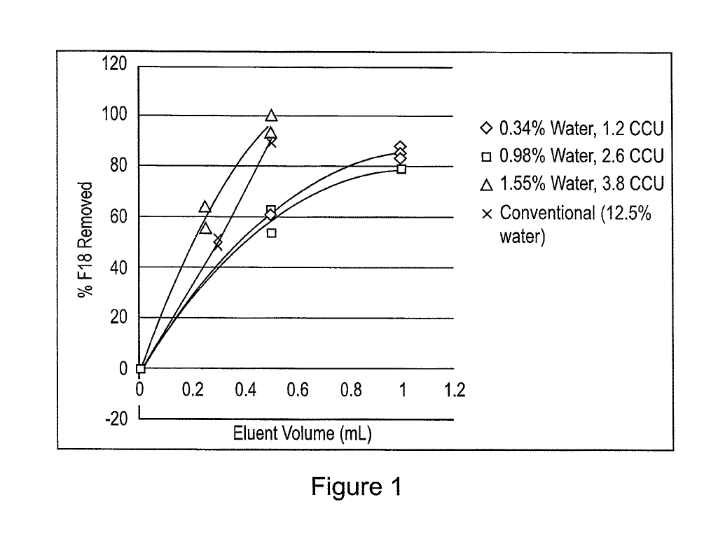

The resulting data is shown in FIG. 1. FIG. 1 compares several example inventive eluents against a conventional eluent at various volumes. As shown in FIG. 1, the 0.95% water with approximately 4 times the complex concentration of the conventional eluent (i.e., 4 CCU) removed a larger percentage of the activity than the conventional eluent having 12.5% water for a given volume. The 0% water and 0.5% water were not able to remove as much fluoride-18 for a given volume as the 0.95% water solution or the 12.5% water solution.

The percent fluoride-18 removed for the low-water eluents was significantly improved over the data shown in Table 1 by increasing the Kryptofix 222-K₂CO₃ complex concentration. Also, the 0.95% water with 3.8 times the complex concentration of the conventional eluent (i.e. 3.8 CCU) removed over 90% of the fluoride-18 activity from the QMA, for a given eluent volume.

### Additional Drying Methods

In certain circumstances additional drying may be useful after the eluent has passed through the column. In particular, as discussed above, in some applications it is possible that it may be desirable to include some water in the eluent. While the bulk of the water of the radioisotope/water solution has been removed through the above method, a small amount of water may remain. In these situations, an additional drying step may be conducted to remove the extra amount of water.

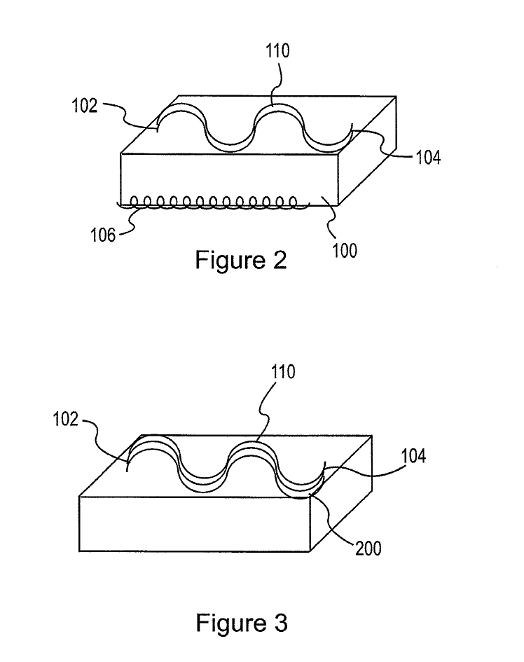

In a first aspect, the eluent having the radioisotopes may pass through a heating block to remove the excess water. As shown in FIG. 2, a heating block 100 may comprise an inlet 102 and an outlet 104. The inlet 102 is in direct or indirect communication with the outlet of the QMA column. The heating block 100 is heated by a heat source 106. The heat source may be any suitable heating source such a heating coil. The heating block is preheated to a temperature sufficient to rapidly heat the eluent having the radioisotopes.

To enhance the fluid heating speed, the heating block 100 includes a winding or serpentine path 110 along a surface of the heating block. The path 110 spreads the fluid out, increasing the surface area, and decreasing the depth so heat can quickly penetrate the fluid. As the fluid is heated in the path 110 the water evaporates and rises out of the block. To further enhance evaporation and to direct the evaporated gas away from the block, a gas stream can be direct to flow over the top of the open path 110. The heating block may be made of a thermally conductive material such as thermally conductive polymers.

In another aspect, as shown in FIG. 3, instead of heating the block itself, a microwave microstrip 200 may be implemented to more directly heat the eluent. Instead of a heat source heating the block, the winding path may include a microwave microstrip 200 inserted directly below the winding path 110 that mirrors the path 110. The microstrip 200 carries microwave energy that causes the fluid to heat when brought into close proximity with each other.

In still another aspect, a microwave antenna can be configured to directly apply microwave radiation to a reaction vessel where the eluent containing fluorine-18 is used to synthesize the radiopharmaceutical. In this aspect, the reaction vessel itself must be made of a material that is penetrable by microwave energy. The microwave energy will quickly heat the fluid which will allow the water to be evaporated. Furthermore, microwave energy has been shown to promote chemical reactions and may assist in speeding the radiopharmaceutical synthesis.

In yet another aspect, the eluent containing radioisotopes may be passed through a desiccant. The desiccant is chosen such that when the fluid passes through the water content of the solution is absorbed.

It is within the scope of the invention that any combination of the above drying methods may follow the eluent drying method to further remove water.

In particular, the drying methods and compositions may be implemented in the minicell such that the solution is dried right before the radiolabeling step.

### Eluent Preparing Methods

It has been surprisingly discovered that the equilibrium reaction between cation trapping agent and salt to cation trapping agent/salt complex could be shifted to the cation trapping agent/salt complex (e.g., Kryptofix-222/potassium carbonate complex), even with very low amounts of water by waiting sufficient time for the complex to form. Additionally, by adding either excess cation trapping agent (e.g., Kryptofix-222) or excess salt (e.g., potassium carbonate) it is believed that higher amounts of complex will be formed in less time compared to using stoichiometric quantities of either cation trapping agent (e.g., Kryptofix-222) or salt (e.g., potassium carbonate). The cation trapping agent/salt complex (e.g., Kryptofix-222/potassium carbonate complex) can be generated with little or no water present, but longer times are needed to reach equilibrium compositions compared to conventional complexes generated in acetonitrile containing a substantial amount of water when generated at ambient temperature.

A first method for preparing such an eluent may be referred to as a resolubilization method. This approach involves initial preparation of the cation trapping agent/salt complex (e.g., Kryptofix-222/potassium carbonate complex) by mixing the cation trapping agent (e.g., Kryptofix-222) and salt (e.g., potassium carbonate) using either a stoichiometric ratio or an excess of either Kryptofix-222 or potassium carbonate in a mixture of non-NMR testing grade solvent (e.g., protio-acetonitrile or commonly called acetonitrile) and water. NMR refers to an analytical technique known as nuclear magnetic resonance spectroscopy. A typical solvent mixture used was 87.5% acetonitrile and 12.5% water on a volume basis. In other words, the initial preparation involves forming the complex using the standard method of having a substantial amount of water.

The mixture is stirred at ambient temperature. Completion or near completion of complexation is indicated by the disappearance or near disappearance of the lower aqueous phase believed to be rich in potassium carbonate, thus strongly suggesting that the salt (e.g., potassium carbonate) had migrated from this phase and was complexed to the cation trapping agent (e.g., Kryptofix-222). Samples removed from these mixtures and examined by NMR spectroscopy indicate that complexation was occurring. At this point, the cation trapping agent/salt complex (e.g., Kryptofix-222/potassium carbonate complex) is obtained by initial stripping on a rotary evaporator to near dryness and then dried further in a vacuum oven containing phosphorous pentoxide using high vacuum. The processing is allowed to continue for as long as it takes for the complex to be completely or near completely dried of all water content.

Once the complex completely or near completely dried, weighted amounts of the dry or nearly dry cation trapping agent/salt complex is then dissolved in NMR testing grade solvent (e.g., deuteroacetonitrile) having little or no water content, at ambient temperature, to which weighed amounts of an internal standard is added. NMR spectroscopy generally requires that the solvent contains some deuterium so that accurate NMR data can be obtained. The progress of the equilibrium reaction is monitored over time using NMR spectroscopy. It has been surprisingly found that, over time, even though little or no water is not present, the complex will solubilize in the solvent. As the equilibrium reaction progresses, data is collected regarding the amount of time that has passed and the amount of complex that has solubilized. Table 4, below, is an example of such data of a complex that was prepared using 42% extra potassium carbonate compared to the quantity needed to react with available Kryprofix-222.

TABLE 4
Dried Kryptofix-222/Potassium Carbonate Complex Added to Deuteroacetonitrile

| | | | | | Effective Complex |
|---|---|---|---|---|---|
| | Initial | | | | Conc. = Init. Conc. × |
| | Complex | Percent | Time | Percent | Percent |
| | Concentration | Water | Since | Solubilized | Solubilized |
| Example | (mg/ml) | (vol/vol) | Mixing | Complex | (mg/ml) |
| 17 | 120 | 0.33 | 1 hour | 37.1 | 44.5 |
| 18 | 120 | 0.33 | 1 day | 39.2 | 47.0 |
| 19 | 120 | 0.33 | 7 day | 56.0 | 67.2 |
| 20 | 120 | 0.33 | 8 day | 58.0 | 69.6 |
| 21 | 176 | 0.97 | 1 hour | 70.6 | 124 |
| 22 | 176 | 0.97 | 7 day | 83.1 | 146 |
| 23 | 214 | 1.54 | 1 hour | 104 | 214 |
| 24 | 214 | 1.54 | 1 day | 103 | 214 |
| 25 | 214 | 1.54 | 7 day | 99 | 212 |

Table 4 indicates that the time required to reach equilibrium is inversely dependent on the water content, wherein equilibrium is more rapidly reached at higher water concentrations. However, the solubilized complex concentrations at low water concentrations (e.g. 0.33%) also continue to regularly increase with time. Similar testing also shows that when extra cation trapping agent (e.g., Kryptofix-222) was added, the percent solubilized complex increased significantly compared to the complex without extra cation trapping agent (e.g., Kryptofix-222) at the same time period. This behavior demonstrates that the equilibrium producing cation trapping agent/salt complex (e.g., Kryptofix-222/potassium carbonate complex) can be shifted towards the desired composition simply by addition of extra cation trapping agent (e.g., Kryptofix-222) when excess potassium carbonate is originally present.

As seen in Table 4, several amounts of initial complex, having very low amounts of water, were tested over time using NMR spectroscopy. Over time, increasing amounts of the initial complex solubilized. It is within the scope of the invention that this data can be prepared for various formulations resulting from the first step to form the initial complex. This data obtained in deuteroacetonitrile acts as a comparative control to prepare solubilized complex using a non-NMR testing grade solvent (e.g., acetonitrile). All of the above steps can be considered a control or comparative run. The control or comparative run need only be prepared as many times as necessary to obtain high confidence in the data and to examine the range of complex concentrations needed for radiopharmaceutical preparation.

After the data has been collected, the eluent is ready to be mass produced. This production can be referred to as the production run. The above steps are identically repeated with acetonitrile in place of deuteroacetonitrile, which is significantly cheaper than deuteroacetonitrile. However, during the production runs, there is no need for further use of NMR spectroscopy. Rather, based on the data collected during the control run, the time for producing the solubilized complex is already known because it is expected that the equilibrium reaction using NMR testing grade solvent (e.g., deuteroacetonitrile) will closely mirror the same reaction using the non-NMR testing grade solvent analog (e.g., acetonitrile). For example, based on the data collected in Table 4, when the initial complex concentration is 120 mg/ml and the water content is 0.33%, the operator knows that after eight days 58.0% of the complex is solubilized.

Additionally, the time required to generate high percentages of complex by the re-solubilization approach should also be advantageously reduced by heating the reaction mixture above ambient temperature or using other methods of energy input such as ultrasound or microwave or combinations thereof. Heating the reaction mixture is particularly important in the preparation of anhydrous complexes since no possible hydrolysis of acetonitrile to acetic acid can occur in this case.

Another method for preparing a suitable eluent may be referred to as a direct preparation method. This approach involves first mixing a cation trapping agent (e.g., Kryptofix-222) and salt (e.g., potassium carbonate) at various mole ratios in solvent (e.g., deuteroacetonitrile) with water contents ranging from low to no water being present (e.g., less than 4% water by volume). The advantage of the direct preparation approach is that a separate drying step is not required after initial formation of the cation trapping agent/salt complex (e.g., Kryptofix-222/potassium carbonate complex).

As with the resolubilization method, the initial run is a comparative or control run in which the equilibrium reaction is followed through NMR spectroscopy. The amount of solubilized complex is periodically recorded for particular combinations of cation trapping agent, salt, and water in deuteroacetonitrile solvent. Table 5 shows Kryptofix-222/potassium carbonate complex formation obtained by the direct reaction of Kryptofix-222 with 42-44 mole percent excess potassium carbonate in deuteroacetonitrile at ambient temperature as measured by NMR spectroscopy.

TABLE 5
Direct Formation of Kryptofix-222/Potassium Carbonate Complex in
Deuteroacetonitrile

| | | Weight | Factor of Excess | | | Percent of |
|---|---|---|---|---|---|---|
| | Weight | Pot. | Pot. Carb. over | | Time | Theoretical |
| | Kryptofix-222 | Carb. | Stoichiometric | Percent | Since | Solubilized |
| Example | (mg) | (mg) | Amount¹ | Water | Mixing | Complex |
| 27 | 127.1 | 33.5 | 1.44 | 0.95 | 1 hour | 37.3 |
| 28 | 127.1 | 33.5 | 1.44 | 0.95 | 1 day | 83.2 |
| 29 | 127.1 | 33.5 | 1.44 | 0.95 | 2 day | 79.6 |
| 30 | 127.1 | 33.5 | 1.44 | 0.95 | 21 day | 92.7 |
| 31 | 77.1 | 20.1 | 1.42 | 0.00 | 1 hour | 27.9 |
| 32 | 77.1 | 20.1 | 1.42 | 0.00 | 1 day | 42.9 |
| 33 | 77.1 | 20.1 | 1.42 | 0.00 | 18 day | 74.7 |

¹Stochiometric ratio of potassium carbonate to Kryptofix-222 is 1:2

Once the control data has been found for the desired combination of cation trapping agent, salt, and water amount, the production run can be performed. The identical reaction is performed, except that the solvent is non-NMR testing grade (e.g., acetonitrile). As with the above method, it is expected that the reaction using non-NMR testing grade solvent (e.g., acetonitrile) will closely mirror the NMR testing grade solvent (e.g., deuteroacetonitrile). During the production run, based on the control data, the operator knows how long to wait to obtain a desired amount solubilized complex. For example, based on Table 5, when combining 127.1 mg/ml of Kryptofix-222 with 33.5 mg/ml of potassium carbonate, with 0.95% water, in acetonitrile solvent, the operator knows that's it will take 21 days to reach 92.7% solubilized complex.

The direct formation approach results in close to 100 percent of the theoretical solubilized Kryptofix-222/potassium carbonate complex over reasonable periods of time while not requiring a drying step followed by a re-solubilization step. Significantly, appreciable quantities of the anhydrous cation trapping agent/salt complex (e.g., Kryptofix-222/potassium carbonate complex) can be generated within reasonable times. Similar results are expected when the excess potassium carbonate factor is incrementally reduced from the values shown in Table 5 down to 1.00.

In general, the time required to generate high percentages of complex should also be advantageously decreased using this method by heating the reaction mixture above ambient temperature or using other methods of energy input such as ultrasound or microwave or combinations thereof. Heating the reaction mixture is particularly important in the preparation of anhydrous complexes since no possible hydrolysis of acetonitrile to acetic acid can occur in this case.

The end result of using either of the above methods is an eluent having solubilized cation trapping agent/salt complex with little or no water content, which can be mass produced easily and cheaply compared to the conventional methods. One of the advantages of the present invention is that the above methods can be applied to the preparation of any cation trapping agent/salt complex. The operator need simply follow the control steps above while replacing the cation trapping agent, salt, and solvent as necessary for the particular context for which the complex will be used. Once the control data is determined, the operator can then mass produce the eluent having the desired solubilized complex concentration in the same manner as described above.

Other examples of cation trapping agents usable in the methods are crown ethers, calixarenes, cyclodextrins, and ethylenediamine tetraacetic acid (EDTA) and its derivatives. Other examples of salts useable in the eluent are salts having a cation from group 1A and 2A elements, and an anion selection from hydroxide, carboxylates, thiocarboxylates, thiolates, and halogens other than fluorine.

As discussed above the cation trapping agent may be a cryptand, available under the trade name Kryptofix, and the salt may be potassium carbonate K₂CO₃. In particular, in a preferred aspect, the cation trapping agent includes 1,10-diaza-4,7,13,16,21,24-hexaoxabicyclo[8.8.8]hexacosane, available under the trade name Kryptofix 222, and the salt includes potassium carbonate K₂CO₃. When the cation trapping agent is Kryptofix 222, the amount used is about 15 mg/mL to about 450 mg/mL, more preferably about 50 mg/mL to about 250 mg/mL. When the salt is potassium carbonate, the amount of used is about 5 mg/mL to about 100 mg/mL.

The eluent that is produced via the above-described methods may then be implemented in above-described drying methods.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

1. A method of drying a radioisotope solution having radioisotopes, the method comprising:
passing the radioisotope solution through a column having an anion exchange group, thereby trapping the radioisotopes in the column; and
passing an eluent through the column, thereby removing the radioisotopes from the column,
wherein the eluent comprises:
a solubilized cation trapping agent/salt complex;
less than 4% by volume water; and
the remainder is a solvent.

2. The method of claim 1, wherein the radioisotopes comprise fluoride-18.

3. The method of claim 2, wherein the anion exchange group comprises a quaternary trimethylammonium group.

4. The method of claim 1, wherein the cation trapping agent/salt complex comprises a cryptand.

5. The method of claim 4, wherein the cryptand comprises 1,10-diaza-4,7,13,16,21,24-hexaoxabicyclo[8.8.8]hexacosane.

6. The method of claim 5, wherein the cation trapping agent/salt complex comprises potassium carbonate.

7. The method of claim 6, wherein the eluent comprises less than 1% by volume water.

8. The method of claim 1, further comprising flushing the column with an organic solvent before passing the eluent through the column.

9. The method of claim 8, further comprising flushing the column with a high pressure inert dry gas after flushing with the organic solvent, but before passing the eluent through the column.

10. The method of claim 8, wherein the organic solvent is acetonitrile.

11. The method of claim 9, wherein the gas is nitrogen.

12. The method of claim 1, further comprising passing the eluent through a heating block after passing the eluent through the column.

13. The method of claim 6, wherein the eluent comprises about 20 mg/mL to about 500 mg/mL of 1,10-diaza-4,7,13,16,21,24-hexaoxabicyclo[8.8.8]hexacosane/potassium carbonate complex.

14. An eluent composition for drying a radioisotope solution having radioisotopes, the composition comprising:
a solubilized cation trapping agent/salt complex;
less than 4% by volume water; and
the remainder is a solvent.

15. The eluent composition of claim 14, wherein the cation trapping agent/salt complex comprises a cryptand.

16. The eluent composition of claim 15, wherein the cryptand comprises 1,10-diaza-4,7,13,16,21,24-hexaoxabicyclo[8.8.8]hexacosane.

17. The eluent composition of claim 14, wherein the cation trapping agent/salt complex comprises potassium carbonate.

18. The eluent composition of claim 14, wherein the eluent comprises less than 1% by volume water.

19. The eluent composition of claim 14, wherein the solvent comprises acetonitrile.

20. The eluent composition of claim 17, wherein the eluent comprises about 20 mg/mL to about 500 mg/mL of 1,10-diaza-4,7,13,16,21,24-hexaoxabicyclo[8.8.8]hexacosane/potassium carbonate complex.

21. A method of making an eluent having a solubilized cation trapping agent/salt complex, less than 4% water and the remainder is a solvent, the method comprising:
reacting a cation trapping agent with a salt in the presence of less than 4% water and a first solvent to form solubilized cation trapping agent/salt complex, wherein one of the cation trapping agent and the salt is present in excess of a stoichiometric amount; and
ending the reaction when a predetermined amount of solubilized cation trapping agent/salt complex has been formed.

22. The method of claim 21, further comprising:
reacting the cation trapping agent with the salt in the presence of less than 4% water and the first solvent to form solubilized cation trapping agent/salt complex until completion or near completion of the reaction, wherein one of the cation trapping agent and the salt is present in excess of a stoichiometric amount; and
determining an amount of cation trapping agent/salt complex that has been solubilized at periodic times throughout reaction until completion of the reaction;
determining a correlation between the amount of cation trapping salt/complex that has been solubilized and an amount of time that the reaction has progressed.

23. The method of claim 22, further comprising:
reacting the cation trapping agent with the salt in the presence of less than 5% water and a second solvent to form solubilized cation trapping agent/salt complex; and
estimating the amount of solubilized cation trapping agent/salt complex that has been formed based on the correlation.

24. The method of claim 23, wherein the first solvent is a deuterated NMR testing grade solvent and the second solvent is non-NMR testing grade solvent.

25. The method of claim 24, wherein the NMR testing trade solvent is deuteroacetonitrile and non-NMR testing grade solvent is acetonitrile.

26. The method of claim 22, wherein the correlation is determined by NMR analysis.

27. The method of claim 21, wherein the cation trapping agent comprises a cryptand.

28. The method of claim 27, wherein the cryptand comprises 1,10-diaza-4,7,13,16,21,24-hexaoxabicyclo[8.8.8]hexacosane.

29. The method of claim 21, wherein the salt comprises potassium carbonate.

30. The method of claim 21, wherein less than 1% by volume water is present.

31. The method of claim 29, wherein from about from about 20 mg/mL to about 500 mg/mL 1,10-diaza-4,7,13,16,21,24-hexaoxabicyclo[8.8.8]hexacosane is present.

32. The method of claim 29, wherein about 5 mg/mL to about 50 mg/mL potassium carbonate is present.
